(19) United States
(12) Patent Application Publication
(10) Pub. No.: US 2026/0141065 A1
(43) Pub. Date: May 21, 2026

(54) DIAGNOSTIC AND REMEDIATION PROCESSES FOR A SECURITY PLATFORM

(71) Applicant: Google LLC, Mountain View, CA (US)

(72) Inventors: Shruti Verma, Gujarat (IN); Rishi Verma, Bihar (IN)

(21) Appl. No.: 18/951,563

(22) Filed: Nov. 18, 2024

(51) Int. Cl. G06F 21/56

(52) U.S. Cl. CPC G06F 21/56; G06F 2221/034

(57) ABSTRACT

A system and method for diagnostic and remediation processes in a security platform. Them method includes determining, by a processing device, a first plurality of performance metrics for respective components of a security platform, generating first performance data of the security platform based on the first plurality of performance metrics, receiving first security data associated with an organization using the security platform, determining, based on the first security data, whether the first performance data satisfies a first security threat criterion with respect to a performance baseline of the security platform for the organization, responsive to determining that the first performance data satisfies the first security threat criterion, identifying, based on the first performance data, a first component of the respective components of the security platform, determining, based on the first performance data, first configuration data for the first component; and applying the first configuration data to the first component.

### TECHNICAL FIELD

Aspects and implementations of the present disclosure relate to diagnostic and remediation processes for a security platform.

### BACKGROUND

In today's digital age, organizations are constantly facing an increasing volume of sophisticated cybersecurity threats. Cybersecurity is the practice of protecting systems, networks, and data from digital attacks, unauthorized access, and damage.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method including: determining, by a processing device, a first plurality of performance metrics for respective components of a security platform; generating first performance data of the security platform based on the first plurality of performance metrics; receiving first security data associated with an organization using the security platform; determining, based on the first security data, whether the first performance data satisfies a first security threat criterion with respect to a performance baseline of the security platform for the organization; responsive to determining that the first performance data satisfies the first security threat criterion, identifying, based on the first performance data, a first component of the respective components of the security platform; determining, based on the first performance data, first configuration data for the first component; and applying the first configuration data to the first component.

In some aspects, the method further comprises determining a second plurality of performance metrics for the respective components of the security platform; generating second performance data of the security platform based on the second plurality of performance metrics; determining, based on the first security data, whether the second performance data satisfies the first security threat criterion; responsive to determining that the second performance data does not satisfy the first security threat criterion, generating a first indication that applying the first configuration data to the first component was successful; and causing the first indication to be visually rendered via a graphical user interface (GUI).

In some aspects, the method further comprises determining a second plurality of performance metrics for the respective components of the security platform; generating second performance data of the security platform based on the second plurality of performance metrics; receiving second security data from the organization using the security platform; determining, based on the second security data, whether the second performance data satisfies the first security threat criterion; responsive to determining that the second performance data satisfies the first security threat criterion, generating a first indication that applying the first configuration data to the first component was unsuccessful; and causing the first indication to be visually rendered via a graphical user interface (GUI).

In some aspects, the first security data comprises fabricated log data.

In some aspects, generating the first performance data based on the first plurality of performance metrics comprises: providing the first plurality of performance metrics as a first input to an artificial intelligence (AI) model trained to generate performance data for the security platform; providing the first security data as a second input to the AI model; and receiving a first output from the AI model, wherein the first output comprises the first performance data.

In some aspects, the method further comprises providing configuration data for the security platform as a third input to the AI model; and receiving a second output from the AI model, wherein the second output comprises the first configuration data for the first component.

In some aspects, the respective components of the security platform include at least one of a data ingestion component, a data parsing component, an alert generation component, or a user access component.

In some aspects, the performance baseline of the security platform for the organization is determined using an artificial intelligence (AI) model trained to generate performance data based on one or more patterns in a plurality of performance metrics, the method further comprising: providing a plurality of historical performance metrics as a first input to the AI model; providing historical security data as a second input to the AI model; and receiving an output from the AI model, wherein the output comprises the performance baseline of the security platform for the organization.

An aspect of the disclosure provides a computer-implemented method including: generating a first training input of a training dataset, the first training input comprising a plurality of performance metrics for respective components of a security platform; generating a second training input of the training dataset, the second training input comprising first security data received from an organization at the security platform, wherein the plurality of performance metrics and the first security data correspond to a shared period of time; generating a first training output corresponding to the first training input and the second training input, wherein the first training output identifies a deviation of current performance data for the security platform from a performance baseline for the security platform; and utilizing the training dataset to train an AI model on (i) a set of training inputs comprising the first training input and the second training input, and (ii) a set of training outputs comprising the first training output.

In some aspects, the first security data comprises fabricated log data.

In some aspects, the method further comprises: generating a third training input comprising historical configuration data for the security platform, wherein the set of training inputs comprises the third training input; and generating a second training output comprising first configuration data for a first component of a plurality of components of the security platform, wherein the set of training outputs comprises the second training output.

In some aspects, the plurality of components comprise at least one of a data ingestion component, a data parsing component, an alert generation component, or a user access component.

An aspect of the disclosure provides a system including a memory and one or more processing devices communicatively coupled to the memory, the one or more processing devices to perform one or more of the operations of either computer-implemented method described above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture, according to aspects of the disclosure.

FIG. 2 is an example training set generator to create training data for a machine learning model, according to some aspects of the disclosure.

FIG. 3 illustrates a flow diagram of an example of a method for training an AI model, according to some aspects of the disclosure.

FIG. 4A illustrates an example of a convolutional neural network (CNN) to train an AI model to determine a deviation of operations of a security platform from a predefined baseline, according to aspects of the disclosure.

FIG. 4B illustrates an example deployment strategy for the CNN of FIG. 4A for determining a deviation of operations of a security platform from a predefined baseline, according to aspects of the disclosure.

FIG. 5 is a flow diagram of an example method for diagnostic and remediation processes for a security platform, according to some aspects of the disclosure.

FIG. 6 is a block diagram illustrating an example of a computer system, according to aspects of the disclosure.

### DETAILED DESCRIPTION

Aspects of the present disclosure relate to diagnostic and remediation processes for a security platform. A security platform can serve one or more clients (e.g., represented by entities such as organizations). The security platform can be part of an online (e.g., virtual) platform that provides clients with a comprehensive suite of productivity tools, programs, and services. The security platform can combine the features of a security information and event management (SIEM) system and a security orchestration, automation, and response (SOAR) system into a unified platform.

The security platform can collect security data from a client organization and provide the client organization with tools to detect, analyze, and respond to incidents described in the collected security data. The security platform can provide a user (e.g., a systems administrator) from the client organization with a graphical user interface (GUI) to access, monitor, use, and configure the tools and functionality of the security platform.

The security platform can obtain security data from a client organization. As used herein, security data can include telemetry data such as log files produced by the operating systems, middleware, and/or applications that reflect actions which occurred at specific moments in time on a computing resource. The security platform can ingest raw data that is received from the client organization. When the raw data is ingested, the security platform may perform one or more pre-processing operations on the raw data. Once the security platform has ingested the raw data, the client organization can use the tools or services of the security platform to perform security actions with the ingested data. The security actions of the security platform can generate one or more of events, detections, or alerts from the ingested data. The security platform can provide notifications based on the events, detections, or alerts that have been generated.

The security platform can be employed to protect the organization's computing environment. Thus, if the security platform is impaired, the potential risk to the organization's computing environment can increase. Security platforms can be impaired due to misconfiguration, misuse, hardware failure, or the like. In particular, when a security platform is misconfigured, the security platform may not be able to provide timely or accurate reports of potential security threats, or the ability of the security platform to analyze potential security threats may be impaired. As used herein, “misconfiguration” can refer to a setup or arrangement of configuration settings of the security platform that have the potential to cause platform vulnerabilities, inefficiencies, errors, or the like. For example, a misconfiguration can occur when the configuration settings for the security platform are improperly set to a state that does not align with the security, performance, or functional requirements of the organization. Misconfigured configuration settings of a security platform can be the result of inexperienced system administrators, equipment failure, misuse, or the like. As used herein, “configuration settings” can refer to adjustable parameters of the security platform that affect the functionality of one or more components of the security platform. Configuration settings may be adjusted by entities such as organization users, third-parties, or systems within or without the organization. Configuration settings for a security platform may be accessible through a security dashboard or GUI. Configuration settings may be stored in data stores connected to the security platform as one of various configuration file types, such as initialization (INI), extensible markup language (XML), or JavaScript Object Notation (JSON) files. As used herein, “configuration data” can represent aggregated numerical or textual representations of configuration settings for a security platform.

When a potential security threat occurs, the primary focus can be to mitigate the potential security threat. Once the threat is mitigated, additional analysis of the security threat may be performed as needed. For example, if an entity (e.g., a user of the organization, unauthorized third party, etc.), performs one or more actions that present a potential security threat, the objective results of the entity's actions are first analyzed and addressed before the intent of the entity's actions are analyzed. However, when the potential security threat is based on an intentional misuse or exploitation of the security platform, analyzing the intent of the entity's actions may play a large roll in mitigating the potential security threat. For example, when the misconfiguration is an accident, changing the configuration settings to the appropriate values can resolve the potential security threat. A follow up analysis may be conducted to determine how the accident occurred, in order to prevent the possibility of future similar accidents. In another example, when the misconfiguration is intentional changing the configuration settings to the appropriate values may only resolve a portion of the potential security threat. This can be especially dangerous when the intentional misconfiguration is done in a way to make it look like an accidental misconfiguration. If the intentional misconfiguration is not identified as intentional, the security platform may remain compromised.

As described above, the security platform can include various components. Each component can perform one or more operations that enable the security platform to protect the client organization's computing environment from potential security threats. Diagnosing a security platform failure can be challenging. Some diagnostic tools may temporarily restrict the functionality components of the security platform, or of the organization's computing environment. Thus, performing the right diagnostics to diagnose the security platform failure with minimal negative repercussions to the functionality of the security platform and the organization's computing environment is an important feature of the security platform. Determining a likely intent of an intentional misconfiguration of the security platform using only objective data from the security platform can be useful for estimating the possibility that other configuration settings of the security platform are misconfigured.

Aspects of the present disclosure address these and other challenges by providing diagnostic and remediation processes for a security platform. The security platform generates performance data based on performance metrics for various components of the security platform. The security platform can determine whether the performance data satisfies a security threat criterion (e.g., by being outside an acceptable tolerance limit of a performance baseline for the security platform). If the performance data satisfies the security threat criterion (e.g., by being outside the acceptable tolerance limit of the performance baseline), the security platform can identify, among components of the security platform, a component that is misconfigured, causing a deviation from the performance baseline. The security platform can perform a remedial action with respect to the identified component, e.g., by reverting the configuration settings for the component to a “last known good” (LNG) version of the configuration data. In some embodiments, the security platform can employ a trained AI model to determine whether the performance data satisfies the security threat criterion.

The security platform can collect performance metrics for each component of the security platform. The performance metrics can be a numerical representation of operations performed by the respective component. For example, performance metrics for a data ingestion component of the security platform may reflect (i) a rate at which data is received from the client organization, (ii) a rate at which the received data is ingested into the security platform, (iii) a ratio between the rate at which data is received and the rate at which data is ingested, or the like. In another example, performance metrics for a data parsing component of the security platform may reflect (i) a percentage of received security data that are identified as a certain data type (e.g., a printer log, etc.), (ii) a common distribution percentages of data fields in the identified data type (e.g., 5% of the printer log is typically timestamp data, 20% of the printer log file is typically job status data, etc.), or the like. In another example, performance metrics for an alert generation component of the security platform may reflect (i) a number of alerts generated for a certain amount of input security data, (ii) a number of alerts generated over a certain period of time, (iii) a percentage of the alerts generated that are of a certain alert type, or the like. In another example, performance metrics for a user access component of the security platform may reflect (i) a number of times a user has accessed a particular component of the security platform, (ii) a number of times a third-party has accessed, or attempted to access, a particular component of the security platform, (iii) time and/or date date for user activity, or the like. In another example, performance metrics for a configuration component of the security platform may reflect (i) a number of changes to the configuration settings of the security platform over a certain period of time, (ii) a number of changes to a particular configuration setting over a certain period of time, or the like. These performance metrics can be collected and used to generate overall performance data for the security platform.

In some embodiments, the security platform can employ a trained AI model to determine a performance baseline of the security platform. The diagnostic model may utilize historical performance data and historical security data for a chosen period of time. As used herein, “normal operations” of the security platform refers to a state in which all components of the security platform and corresponding computing environment function as designed, and produce correct (e.g., predictable) outputs corresponding to the received inputs.

The same, or another AI model can be trained to identify a deviation from the determined performance baseline, based on current performance data and current security data from the chosen period of time. In some implementations, the AI model can be trained to identify patterns of misconfigurations in the security platform that may be related to the identified deviation from the determined baseline of normal operations. For example, patterns of misconfigurations may indicate intentional misconfigurations of the security platform instead of accidental misconfiguration of the security platform, and may be identified based on one or more shared characteristics. Examples of consistent patterns of misconfigurations may include a group of misconfigurations occurring within a predefined time interval, a group of misconfigurations performed by the same entity (e.g., a user of the organization or a third-party), or the like. In some implementations, the AI model is trained to identify misconfigurations in the security platform that have one or more commonalities (e.g., common user, common time period, etc.). The same, or another AI model can be trained to determine one or more remediation actions that can be performed to return the security platform to the performance baseline. For example, configuration settings for one or more components of the security platform can be reverted respectively to previous versions of configuration settings. Once the one or more remediation actions are performed, the security platform can verify whether the performance of the security platform has returned to the performance baseline.

Advantages of providing for diagnostic and remediation processes for a security platform include improved self-diagnostics of a security platform, an improved ability of the security platform to self-identify and self-correct system errors, an improved detection of potential security threats, and an improved efficiency in overall security threat detection and remediation by the security platform.

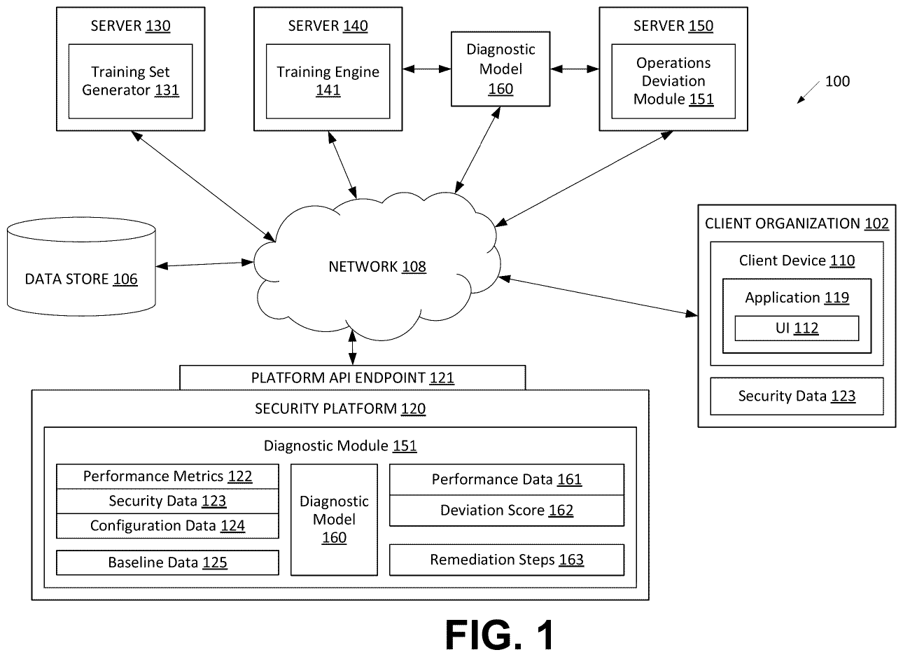

FIG. 1 illustrates an example of a system 100, according to some aspects of the disclosure. The system 100 includes a client organization 102, a data store 106, security platform 120, and one or more server machines, server machine 130, server machine 140, and server machine 150 each connected to a network 108.

In some implementations, network 108 can include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

Data store 106 is a persistent storage that is capable of storing data as well as data structures to tag, organize, and index the data. In some implementations, data can include one or more of structured data, unstructured data, vectorized data, etc., or types of digital files, including text data, audio data, image data, video data, multimedia, interactive media, data objects, and/or any suitable type of digital resource, among other types of data. An example of data stored at the data store 106 can include a file, database record, database entry, programming code or document, among others. The data store 106 can be hosted by one or more storage devices, such as main memory, magnetic or optical storage based disks, tapes or hard drives, network-attached storage (NAS), storage area network (SAN), and so forth. In some implementations, the data store 106 can be a network-attached file server, while in other implementations the data store 106 can be another type of persistent storage such as an object-oriented database, a relational database, and so forth, that can be hosted by security platform 120, or one or more different machines coupled to the server hosting the security platform 120 via the network 108.

The client organization 102 can be an organization that is using one or more services of the security platform 120. For example, the client organization 102 can use or access one or more features of the security platform 120. In some implementations, the client organization 102 can include one or more client devices 110. The client devices 110 can each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, client devices 110 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components. Although a single client device (i.e., client device 110) is illustrated, the system 100 can include one or more client devices in some implementations.

In some implementations, the client device 110 can implement or include one or more applications. In some implementations, the application 119 can be used to communicate (e.g., send and receive information) with the security platform 120. In some implementations, the application 119 can implement user interfaces (UIs) (e.g., graphical user interfaces (GUIs)), such as a user interface (UI) (e.g., UI 112) that may be webpages rendered by a web browser and displayed on the client device 110 in a web browser window. In other implementations, the UIs 112 of the application 119 may be included in a stand-alone application downloaded to the client device 110 and natively running on the client device 110. In some implementations, one or more portions of the diagnostic module 151 can be implemented as part of application 119. In other implementations, diagnostic module 151 can be separate from application 119 and application 119 can interface with diagnostic module 151 via the security platform 120. In some implementations, the client devices 110 may also collect input from users through input features.

In some implementations, a UI 112 may include various visual elements (e.g., UI elements) and regions, and can be a mechanism by which the user engages with the security platform 120, and system 100 at large. In some implementations, the UI 112 of a client device 110 can include multiple visual elements and regions that enable presentation of information, for decision-making, content delivery, etc. at a client device 110. In some implementations, the UI 112 may sometimes be referred to as a graphical user interface (GUI)).

In some implementations, the UI 112 and/or client device 110 can include input features to intake information from a client device 110. In one or more examples, a user of client device 110 can provide input data (e.g., a user query, control commands, etc.) into an input feature of the UI 112 or client device 110, for transmission to the security platform 120, and system 100 at large. Input features of UI 112 and/or client device 110 can include space, regions, or elements of the UI 112 that accept user inputs. For example, input features may include visual elements (e.g., GUI elements) such as buttons, text-entry spaces, selection lists, drop-down lists, etc. For example, in some implementations, input features may include a chat box which a user of client device 110 can use to input textual data (e.g., a user query). The application 119 can then transmit that textual data via the client device 110 to the security platform 120, and the system 100 at large, for further processing. In other examples, input features can include a selection list, in which a user of client device 110 can input selection data e.g., by selecting, or clicking. The application 119 via client device 110 can then transmit that selection data to security platform 120, and the system 100 at large, for further processing.

In some implementations, a client device 110 can access the security platform 120 through network 108 using one or more application programming interface (API) calls via platform API endpoint 121. In some implementations, security platform 120 can include multiple platform API endpoints 121 that can expose services, functionality, or information of the security platform 120 to one or more client devices 110. In some implementations, a platform API endpoint 121 can be one end of a communication channel, where the other end can be another system, such as a client device 110 associated with a user account. In some implementations, the platform API endpoint 121 can include or be accessed using a resource locator, such a universal resource identifier (URI), universal resource locator (URL), of a server or service. The platform API endpoint 121 can receive requests from other systems, and in some cases, return a response with information responsive to the request. In some implementations, HTTP (Hypertext Transfer Protocol), HTTPS (Hypertext Transfer Protocol Secure) methods (e.g., API calls) can be used to communicate to and from the platform API endpoint 121.

In some implementations, the platform API endpoint 121 can function as a computer interface through which access requests are received and/or created. In some implementations, the platform API endpoint 121 can include a platform API whereby external entities or systems can request access to services and/or information provided by the security platform 120. The platform API can be used to programmatically obtain services and/or information associated with a request for services and/or information.

In some implementations, the API of the platform API endpoint 121 can be any suitable type of API such as a REST (Representational State Transfer) API, a GraphQL API, a SOAP (Simple Object Access Protocol) API, and/or any suitable type of API. In some implementations, the security platform 120 can expose through the API, a set of API resources which when addressed can be used for requesting different actions, inspecting state or data, and/or otherwise interacting with the security platform 120. In some implementations, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the security platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some implementations, any element, such as server machine 130, server machine 140, server machine 150, and/or data store 106 may include a corresponding API endpoint for communicating with APIs.

In some implementations, the security platform 120 may include one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to data or services. Such computing devices can be positioned in a single location or can be distributed among many different geographical locations. For example, security platform 120 can include a plurality of computing devices that together may comprise a hosted computing resource, a grid computing resource, or any other distributed computing arrangement. In some implementations, the security platform 120 can correspond to an elastic computing resource where the allotted capacity of processing, network, storage, or other computing-related resources may vary over time.

In some implementations, the security platform 120 can provide tools for the client organization 102 to configure settings of the security platform 120. In some implementations, the configuration settings of the security platform 120 can be represented by configuration data 124. Configuration data 124 can include machine readable instructions (e.g., computer code) that enable one or more of user access controls, network security settings, endpoint security settings, data protection controls, incident response and management controls, monitoring and assessment controls, or the like as part of the security platform 120. For example, configuration data 124 can reflect machine readable instructions that, when executed, implement user access controls for a database.

The security platform 120 can include an diagnostic module 151. The diagnostic module 151 can obtain and provide inputs to the diagnostic model 160. In some implementations, inputs to the diagnostic model 160 can include performance metrics 122, security data 123, configuration data 124, and/or baseline data 125, each of which are described herein, below.

Performance metrics 122 can reflect numerical representations of how respective components of the security platform 120 operate. In some implementations, performance metrics 122 can be numerical values that are averaged over a certain time interval. For example, a performance metric can reflect a number of security data items that are received at the security platform 120 over a predefined time interval. In some implementations, the performance metrics 122 may include one or more of data ingestion metrics, data parsing metrics, alert generation metrics, user access metrics, change metrics reflecting one or more changes to the security platform 120 that are caused by an entity (e.g., an organization user, system, third-party, etc.), or the like. Data ingestion metrics can reflect one or more of a volume, type, source, or ingestion frequency of security data, or the like. Data parsing metrics can reflect one or more attributes that describe a particular data item, such as a data item type, a particular event associated with the data item, a count of events, event attributes, or the like. Alert generation metrics can reflect a status of a security rule affected by a particular data item (e.g., whether the rule is functioning, how often the rule is triggered, etc.), a volume of generated alerts, or the like. User access metrics can reflect a data access request, a timestamp of the data access request, an accessed data type, user identifiers, other actions performed by the user, or the like. Change metrics can reflect a history of changes to a particular component of the security platform 120, entity actions (e.g., what user/system/third-party performed the change), a significance of the change (e.g., how much of the configuration setting was changed in comparison to a previous version), or the like. The performance metrics 122 can be based on objective, or numerical metadata that corresponds to respective components of the security platform 120. In some implementations, a single component of the security platform 120 can have multiple performance metrics 122. For example, an ingestion component of the security platform (not illustrated) can have a (i) “security data received” performance metric, and a (ii) “security data ingested” performance metric.

Security data 123 can be security data received or obtained from a client organization 102, and as described above can include telemetry data such as log files produced the operating systems, middleware, and/or applications that reflect actions which occurred at specific moments in time on a computing resource of the client organization 102.

Configuration data 124 can represent aggregated numerical or textual representations of configuration settings for the security platform 120, as described above. In some implementations, the configuration data 124 is stored in the data store 106, and can be accessed by the diagnostic module 151. In some implementations, the configuration data 124 can represent the configuration settings for the security platform 120 as any other type of processable data. In some implementations, the diagnostic module 151 can change or update one or more configuration settings represented by the configuration data 124.

Baseline data 125 can represent performance data for a normal operation of the security platform 120, based on historical performance metrics, security data, and/or configuration data. Baseline data 125 can include one or more numerical representation indicating how the security platform 120 has processed the security data 123. In some implementations, the baseline data 125 can include one or more numerical representations indicating a performance of a data ingestion component, a data parsing component, an alert generation component, a user access component, or a configuration settings changes component of the security platform 120. In some implementations, the baseline data 125 can include historical performance data, (e.g., baseline data 125) determined by the diagnostic model 160 using historical performance metrics, security data, and/or configuration data. In some implementations, the baseline data 125 can reflect historical performance data. The historical performance data can be determined by the diagnostic model 160 based on labeled historical input data that is labeled historical baseline data for the security platform 120. In some implementations, the baseline data 125 can be based in part on data obtained by the security platform 120 from one or more client organizations 102 that use the security platform 120. For example, baseline data 125 for a particular financial institution may be based in part on baseline data 125 for other client financial institutions that use the same, or similar instance of the security platform 120. In some implementations, the baseline data 125 are not independent from the diagnostic model 160. That is, the baseline data 125, as illustrated here, can be a learned set of parameter values by the diagnostic model 160 based on how the diagnostic model 160 is trained. In some implementations, the baseline data 125 can be ground truth data that is used as a training input to train the diagnostic model 160 to determine whether a received input (e.g., current data) corresponds to a normal performance of the security platform.

The diagnostic module 151 can obtain and process outputs from the diagnostic model 160. In some implementations, outputs from the diagnostic model 160 can include one or more of performance data 161, deviation scores 162, or remediation steps 163, each of which are described herein, below.

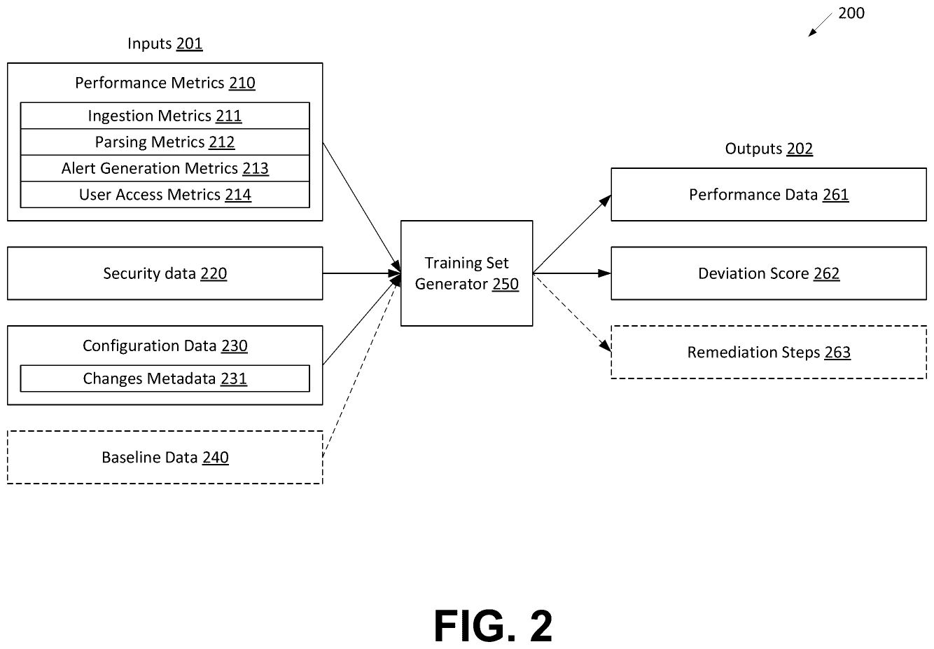

Performance data 161 can represent an overall performance of the security platform 120, based on the performance metrics 122 and the security data 123. In some implementations, the performance data 161 can reflect a current performance of the security platform 120 (e.g., when current performance metrics, current security data, and/or current configuration data are used as inputs). In some implementations, the performance data 161 can reflect a historical performance of the security platform 120 (e.g., when historical inputs are used, such as when generating baseline data 125). The diagnostic module 151 can be trained to identify one or more patterns or trends in the performance metrics 122 of various components of the security platform 120, and generate an overall platform health or performance. For example, if the performance metrics 122 for a data ingestion component change significantly, but the performance metrics for a data parsing component do not experience a similar or corresponding change, the performance data 161 can be trained to identify and report the discrepancy. In another example, if the performance metrics 122 for the data ingestion component change significantly, but characteristics such as the volume or type of security data 123 that is received at the security platform 120 does not experience a similar or corresponding change, the performance data 161 can be trained to identify and report the discrepancy. Additional details regarding the performance data 161, including how the diagnostic model 160 can use the performance metrics 122, security data 123, and/or configuration data 124 to generate the performance data 161 are described below with reference to FIG. 2.

The deviation score 162 can represent a difference between the performance data 161, and the baseline data 125. In some implementations, where the baseline data 125 is a dataset stored or accessed by the diagnostic module 151, the deviation score 162 is not an output of the diagnostic model 160, but rather is calculated by the diagnostic module 151 based on the performance data 161 output and the baseline data 125 dataset. In alternative implementations where the baseline data 125 is incorporated into the diagnostic model 160 (e.g., the diagnostic model 160 has been trained to incorporate the baseline data 125), the deviation score 162 can be a numerical output, such as a statistical representation, that indicates a level of confidence that the performance data 161 corresponds to the baseline data 125. In such implementations, a lower level of confidence can indicate a larger deviation of the performance data 161 from the baseline data 125, whereas a higher level of confidence can indicate a smaller deviation.

The remediation steps 163 can represent one or more actions that can be performed to reduce the deviation score 162, such that the performance data 161 more closely matches the baseline data 125. In some implementations, remediation steps 163 are not an output of the diagnostic model 160, but rather, the diagnostic module 151 determines one or more remediation steps 163 based on the performance data 161 and/or the deviation score 162. In alternative implementations, the configuration data 124 can be an input to the diagnostic model 160, and the remediations steps 163 can indicate one or more changes to the configuration data 124 that may reduce the deviation score 162. For example, the configuration data 124 can indicate that a change was recently made to configuration settings for the ingestion component. The diagnostic model 160 can generate an output of remediation steps 163 that indicates that a reversion to previous configuration settings may reduce the deviation score 162.

In some implementations, remediation steps 163 can be specific to a particular component of the security platform 120, such as a data ingestion component, a data parsing component, an alert generation component, or a user access component, as described herein below.

In some implementations, remediation steps 163 for a data ingestion component can include one or more of (i) investigating received security data for indications of an error at the source of the security data, (ii) analyzing the received security data for shared anomalies that have been identified in security data, (iii) monitoring system resources of the security platform, (iv) increasing or decreasing the ingestion capacity of the ingestion component, (v) verifying functionality of hardware components in the client organization or in the security platform, (vi) reviewing the security data for indications of fabricated data, (vii) analyzing network traffic, particularly network traffic related to particular security data (e.g., security data including fabricated data), (viii) changing access controls to configuration settings for the ingestion component, (ix) changing input validation for the security data at the ingestion component, (x) creating or updating security rules based on determined patterns in the security data, or (xi) adjusting baseline performance metrics associated with the ingestion component.

In some implementations, remediation steps 163 for a data parsing component can include one or more of (i) reviewing configuration settings for the data parsing component for errors, (ii) identifying unexpected data security types or formats, (iii) analyzing security events that may have been impacted by the misconfigured data parsing component to determine one or more shared characteristics of the security events, (iv) re-parsing security data that was parsed by the misconfigured data parsing component, (v) comparing a number of security events that occur based on currently parsed data with historical averages of the number of security events, (vi) determining an impact on the number or type of events triggered by incorrectly parsed data, or (vii) comparing parsed data from the data parsing component with raw data received from the organization, or with ingested data received from the ingestion component to identify inconsistencies in the parsed data.

In some implementations, remediations steps 163 for an alert generation component can include one or more of (i) creating, deleting, changing, enabling, or disabling one or more security rules, (ii) changing user authorization settings for creating, deleting, changing, enabling, or disabling security rules, (iii) reviewing access history to identify entity access patterns or unauthorized accesses of the alert generation component, (iv) determining whether security events were improperly triggered due to a misconfigured alert generation component, (v) quarantining security rules with suspicious logic, (vi) investigating the purpose of security rules that have been misconfigured, (vii) reviewing rule creation and modification processes (e.g., user authentications, user interfaces, etc.), (viii) analyzing increases or decreases in the volume of generated alerts to identify potential patterns, or (ix) adjusting security rules.

In some implementations, remediation steps 163 for a user access component include one or more of (i) changing user access controls or authorization for various components of the security platform, (ii) investigating unauthorized accesses and the potential for data breaches, (iii) implementing additional authentication factors for access to various components of the security platform (e.g., multi-factor authentication), (iv) analyzing user access data for potentially suspicious patterns, such as unusual user access times, large data exports, etc., (v) investigating user accounts for potential insider threats, (vi) investigating user accounts that may be compromised by a third-party or unauthorized user, (vii) monitoring user account activity for organization and/or security platform policy violations, or attempted violations.

In some implementations, security platform 120 may generate, modify, and monitor the client-side UIs (e.g., graphical user interfaces (GUI)) and associated components that are presented to users of the security platform 120 through UI 112 client devices 110. For example, diagnostic module 151 can generate the UIs (e.g., UI 112 of client device 110) that users interact with while engaging with the security platform 120.

In some implementations, the diagnostic model 160 is an artificial intelligence (AI), or a machine learning model. An AI model can include a discriminative machine learning model (also referred to as “discriminative AI model” herein), a generative machine learning model (also referred to as “generative AI model” herein), and/or other AI model or machine learning model.

In some implementations, a discriminative AI model can model a conditional probability of an output for given input(s). A discriminative AI model can learn the boundaries between different classes of data to make predictions on new data. In some implementations, a discriminative AI model can include a classification model that is designed for classification tasks, such as learning decision boundaries between different classes of data and classifying input data into a particular classification. Examples of discriminative AI models include, but are not limited to, support vector machines (SVM) and neural networks.

In some implementations, a generative AI model learns how the input training data is generated and can generate new data (e.g., original data). A generative AI model can model the probability distribution (e.g., joint probability distribution) of a dataset and generate new samples that often resemble the training data. Generative AI models can be used for tasks involving image generation, text generation and/or data syn-thesis. Generative AI models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

Server machine 130 includes a training set generator 131 that is capable of generating training data (e.g., a set of training inputs and a set of target outputs) to train a diagnostic model 160 (e.g., a discriminative machine learning model). In some implementations, training set generator 131 can generate the training data based on various data (e.g., stored at data store 106 or another data structure connected to system 100 via the network 108). The data store 106 can store metadata associated with the training data.

Server machine 140 includes a training engine 141 that is capable of training a diagnostic model 160 using the training data from training set generator 131. The diagnostic model 160 (also referred to “machine learning model” or “artificial intelligence (AI) model” herein) may refer to the model artifact that is created by the training engine 141 using the training data that includes training inputs (e.g., features) and corresponding target outputs (correct answers for respective training inputs) (e.g., labels). The training engine 141 may find patterns in the training data that map the training input to the target output (the answer to be predicted) and provide the diagnostic model 160 that captures these patterns. The diagnostic model 160 may be composed of, e.g., a single level of linear or non-linear operations (e.g., a support vector machine (SVM), or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. Diagnostic model 160 can use one or more of a support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc. For convenience rather than limitation, the remainder of this disclosure describing a discriminative machine learning model will refer to the implementation as a neural network, even though some implementations might employ other types of learning machine instead of, or in addition to, a neural network.

In some implementations, such as with a supervised machine learning model, the one or more training inputs of the set of the training inputs are paired with respective one or more training outputs of the set of training outputs. The training input-output pair(s) can be used as input to the machine learning model to help train the machine learning model to determine, for example, patterns in the data.

In some implementations, the diagnostic model 160 can be a generative AI model. A generative AI model is an AI model which can generate new, original data. A diagnostic model 160 can include a generative adversarial network (GAN) and/or a variational autoencoder (VAE). In some instances, a GAN, a VAE, and/or other types of generative AI models can employ different approaches to training and/or learning the underlying probability distributions of training data, compared to some AI models.

For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

In some implementations, the diagnostic model 160 can be a generative large language model (LLM). In some implementations, the diagnostic model 160 can be a large language model that has been pre-trained on a large corpus of data so as to process, analyze, and generate human-like text based on given input.

In some implementations, the diagnostic model 160 may have any architecture for LLMs, including one or more architectures as seen in Generative Pre-trained Transformer (GPT) series (Chat GPT series LLMs), Google's Gemini®, or LaMDA, or leverage a combination of transformer architecture with pre-trained data to create coherent and contextually relevant text.

In some implementations, a diagnostic model 160, such as an LLM, can use an encoder-decoder architecture including one or more self-attention mechanisms, and one or more feed-forward mechanisms. In some implementations, the diagnostic model 160 can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A diagnostic model 160 can also utilize the previously discussed deep learning techniques, including recurrent neural networks (RNNs), convolutional neural networks (CNNs), or transformer networks.

In some implementations, the diagnostic model 160 can be a multi-modal generative AI model, such as a Visual-Language Model (VLM). In some implementations, the diagnostic model 160 can be a VLM that has been pre-trained on a large corpus of data (e.g., textual data and image data) so as to process, analyze, and generate human-like text and/or image data based on given input (e.g., image data and/or natural language text).

In some implementations, training a generative AI model can include providing training input to a diagnostic model 160, and the diagnostic model 160 can produce one or more training outputs. The one or more training inputs can be compared to one or more evaluation metrics. An evaluation metric can refer to a measure used to assess the output (e.g., training output(s)) of a AI model, such as a diagnostic model 160. In some implementations, the evaluation metric can be specific to the task and/or goals of the AI model. Based on the comparison, one or more parameters and/or weights of the diagnostic model 160 can be adjusted (e.g., backpropagation based on computed loss). In some implementations, and for example, the one or more training outputs can be compared to an evaluation metric such as a ground truth (e.g., target output, such as a correct or better answer). In some implementations and for example, the one or more training outputs can be evaluated/compared to an evaluation metric and can be rewarded (e.g., evaluated as a positive answer) or penalized (e.g., evaluated as a negative answer) based on the quality of the one or more training outputs (e.g., reinforcement learning).

In some implementations, a validation engine (not shown) may be capable of validating a diagnostic model 160 using a corresponding set of features of a validation set from the training set generator. In some implementations, the validation engine may determine an accuracy of each of the trained generative models, such as diagnostic model 160 (e.g., accuracy of the training output) based on the corresponding sets of features of the validation set. The validation engine may discard a trained diagnostic model 160 that has an accuracy that does not meet a threshold accuracy. In some implementations, a selection engine not shown) may be capable of selecting a diagnostic model 160 that has an accuracy that meets a threshold accuracy. In some implementations, the selection engine may be capable of selecting the trained diagnostic model 160 that has the highest accuracy of the trained generative models (e.g., diagnostic model 160).

A testing engine (not shown) may be capable of testing a trained diagnostic model 160 using a corresponding set of features of a testing set from the training engine 141. For example, a first trained diagnostic model 160 that was trained using a first set of features of the training set may be tested using the first set of features of the testing set. The testing engine may determine a trained diagnostic model 160 that has the highest accuracy of all of the trained AI models based on the testing sets.

In some implementations, a diagnostic model 160 can be trained on a corpus of data, such textual data and/or image data. In some implementations, the diagnostic model 160 can be a model that is first pre-trained on a corpus of text to create a foundational model (e.g., also referred to as “pre-trained model” herein), and afterwards adapted (e.g., fine-tuned or transfer learning) on more data pertaining to a particular set of tasks to create a more task-specific or targeted generative AI model (e.g., also referred as an “adapted model” herein.) The foundational model can first be pre-trained using a corpus of data (e.g., text and/or images) that can include text and/or image content in the public domain, licensed content, and/or proprietary content (e.g., proprietary organizational data). The diagnostic model 160 can use pre-training to learn broad image elements and/or broad language elements including general sentence structure, common phrases, vocabulary, natural language structure, and any other elements commonly associated with natural language in a large corpus of text. In example, the pre-trained model can be fine-tuned to the specific task or domain that the diagnostic model 160 is to be adapted. In some implementations, diagnostic model 160 may include one or more pre-trained models or adapted models.

In some implementations, training data, such as training input and/or training output, and/or input data to a trained machine learning model (collectively referred to as “machine learning model data” herein) can be preprocessed before providing the aforementioned data to the (trained or untrained) machine learning model (e.g., discriminative machine learning model and/or generative machine learning model) for execution. Preprocessing as applied to machine learning models (e.g., discriminative machine learning model and/or generative machine learning model) can refer to the preparation and/or transformation of machine learning model data.

In some implementations, preprocessing can include data scaling. Data scaling can include a process of transforming numerical features in raw machine learning model data such that the preprocessed machine learning model data has a similar scale or range. For example, Min-Max scaling (Normalization) and/or Z-score normalization (Standardization) can be used to scale the raw machine learning model. For instance, if the raw machine learning model data includes a feature representing temperatures in Fahrenheit, the raw machine learning model data can be scaled to a range of [0, 1] using Min-Max scaling.

In some implementations, preprocessing can include data encoding. Encoding data can include a process of converting categorical or text data into a numerical format on which a machine learning model can efficiently execute. Categorical data (e.g., qualitative data) can refer to a type of data that represents categories and can be used to group items or observations into distinct, non-numeric classes or levels. Categorical data can describe qualities or characteristics that can be divided into distinct categories, but often does not have a natural numerical meaning. For example, colors such as red, green, and blue can be considered categorical data (e.g., nominal categorical data with no inherent ranking). In another example, “small,” “medium,” and “large” can be considered categorical data (ordinal categorical data with an inherent ranking or order). An example of encoding can include encoding a size feature with categories [“small,” “medium,” “large”] by assigning 0 to “small,” 1 to “medium,” and 2 to “large.”

In some implementations, preprocessing can include data embedding. Data embedding can include an operation of representing original data in a different space, often of reduced dimensionality (e.g., dimensionality reduction), while preserving relevant information and patterns of the original data (e.g., lower-dimensional representation of higher-dimensional data). The data embedding operation can transform the original data so that the embedding data retains relevant characteristics of the original data and is more amenable for analysis and processing by machine learning models. In some implementations embedding data can represent original data (e.g., word, phrase, document, or entity) as a vector in vector space, such as continuous vector space. Each element (e.g., dimension) of the vector can correspond to a feature or property of the original data (e.g., object). In some implementations, the size of the embedding vector (e.g., embedding dimension) can be adjusted during model training. In some implementations, the embedding dimension can be fixed to help facilitate analysis and processing of data by machine learning models.

In some implementations, the training set is obtained from server machine 130. Server machine 150 includes a diagnostic module 151 that provides current data (e.g., log information, etc.) as input to the trained machine learning model (e.g., diagnostic model 160) and runs the trained machine learning model (e.g., diagnostic model 160) on the input to obtain one or more outputs.

In some implementations, the training set (or fine-tuning training set) can include training inputs reflecting security posture information obtained by the security platform 120 from the client organizations 102 that use the security platform 120. In some implementations, the security posture information can include usage data (e.g., how a client organization 102 uses the security platform 120, configuration data, etc.), information about the client organization 102 (e.g., an industry, a real or estimated technical sophistication of the organization, etc.), information or configuration data provided or suggested by the security platform 120, or the like. In some implementations, the training set can include training outputs reflecting machine-readable instructions that correspond to the training inputs. In some implementations, the training inputs can be paired to the training outputs. For example, the training input can indicate the values of certain configuration data, and the paired training output can reflect machine-readable instructions that when executed, set the values of configuration data to the values received in the training input. In some implementations, the training inputs can be generated (by another process, system or AI model) for specific training, or target outputs. For example, a target output that reflects machine-readable instructions that when executed, set configuration data to certain values can have a training input generated that describes the output in natural language. In a particular example, a paired training input can be created by a system, process, or other model (e.g., such as a human evaluator), “General user accounts have limited access permissions, and are restricted to databases A and B. Administrator user accounts do not have limited access permissions and can access databases A, B, and C.” This training input can be paired with the target output (which reflects machine-readable instructions that when executed, set the access permissions for user accounts), and used in the training set to train, or fine-tune the diagnostic model 160.

In some implementations, the diagnostic model 160 can generate confidence data. Confidence data can include or indicate a level of confidence that a particular output (e.g., output(s)) corresponds to one or more inputs of the machine learning model (e.g., trained machine learning model). In one example, the level of confidence is a real number between 0 and 1 inclusive, where 0 indicates no confidence that output(s) corresponds to a particular one or more inputs and 1 indicates absolute confidence that the output(s) corresponds to a particular one or more inputs. In some implementations, confidence data can be associated with inference using a machine learning model.

In some implementations, a machine learning model, such as diagnostic model 160, may be (or may correspond to) one or more computer programs executed by processor(s) of server machine 140 and/or server machine 150. In other implementations, a machine learning model may be (or may correspond to) one or more computer programs executed across a number or combination of server machines. For example, in some implementations, machine learning models may be hosted on the cloud, while in other implementations, these machine learning models may be hosted and perform operations using the hardware of a client device 110. In some implementations, the machine learning models may be a self-hosted machine learning model, while in other implementations, machine learning models may be external machine learning models accessed by an API.

In some implementations, server machines 130 through 150 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to one or more data items of the security platform 120. The security platform 120 can also include a website (e.g., a webpage) or application back-end software that can be used to provide users with access to the security platform 120.

In some implementations, one or more of server machine 130, server machine 140, diagnostic model 160, server machine 150 can be part of security platform 120. In other implementations, one or more of server machine 130, server machine 140, server machine 150, or diagnostic model 160 can be separate from security platform 120 (e.g., provided by a third-party service provider).

Also as noted above, for purposes of illustration, rather than limitation, aspects of the disclosure describe the training of a machine learning model (e.g., diagnostic model 160) and use of a trained machine learning model (e.g., diagnostic model 160). In other implementations, a heuristic model or rule-based model can be used as an alternative. It should be noted that in some other implementations, one or more of the functions of security platform 120 can be provided by a greater number of machines. In addition, the functionality attributed to a particular component of the security platform 120 can be performed by different or multiple components operating together. Although implementations of the disclosure are discussed in terms of security platforms, implementations can also be generally applied to any type of platform or service.

In general, functions described in implementations as being performed by security platform 120, client organization 102, and/or server machine 140 can also be performed on the client device 110 in other implementations, if appropriate. In addition, the functionality attributed to a specific component can be performed by different or multiple components operating together. The security platform 120 can also be accessed as a service provided to other systems or devices through appropriate application programming interfaces, and thus is not limited to use in websites.

In implementations of the disclosure, a “user” can be represented as a single individual. For example, a user of the client device 110. However, other implementations of the disclosure encompass a “user” being an entity controlled by a set of users and/or an automated source (e.g., client organization 102). For example, a set of individual users federated as a community in a social network can be considered a “user.” In another example, an automated consumer can be an automated ingestion pipeline of security platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a specific location of a user cannot be determined. Thus, the user can have control over what information is collected about the user, how that information is used, and what information is provided to the user.

FIG. 2 is an example training set generator to create training data for a machine learning model, according to some aspects of the disclosure. System 200 illustrates a training set generator 250, inputs 201 and outputs 202. System 200 can include similar component as system 100, as described with reference to FIG. 1. Components described with reference to FIG. 1 can be used to help describe the system 200 of FIG. 2. In some implementations, the system 200 can illustrate training inputs and target outputs used to train the diagnostic model 160 of FIG. 1.

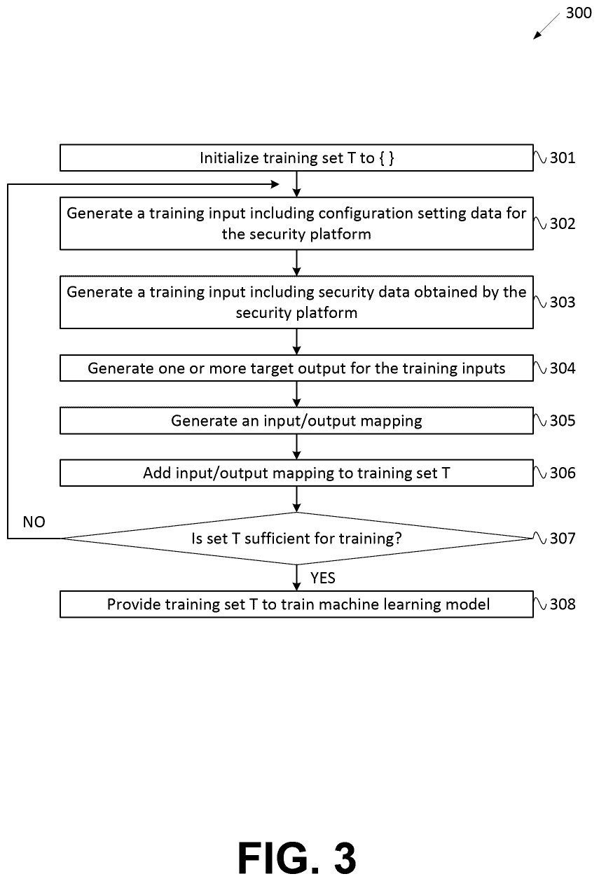

In implementations, the training set generator 250 generates training data that includes one or more training such as inputs 201, and one or more target outputs such as outputs 202. The training data can include mapping data that maps the inputs 201 to the outputs 202. Inputs 201 can be referred to as “features,” “attributes,” or “information.” In some implementations, training set generator 250 can provide the training data in a training set, and provide the training set to a training engine, such as training engine 141 described with reference to FIG. 1, where the training set is used to train the diagnostic model 160. Generating a training set is further described with reference to FIG. 3.

Inputs 201 can include performance metrics 210, security data 220, configuration data 230, and baseline data 240, each of which are further described herein.

Performance metrics 210 includes ingestion metrics 211, parsing metrics 212, alert generation metrics 213, and user access metrics 214, each of which are further described herein. The performance metrics 210 are numerical representations of the performance of one or more components of the security platform 120. The performance metrics 210 can be collected by the security platform 120 and processed by a trained AI model, such as the diagnostic model 160, to determine an overall performance of the security platform 120. In some implementations, the AI model is trained to identify discrepancies within the performance metrics 210, or between the performance metrics 210 and other inputs to the trained AI model. These discrepancies can affect the output 202 received from the trained AI model indicating the performance of the security platform 120 (e.g., with the performance data 261, and/or the deviation score 262).

The ingestion metrics 211 can indicate a performance of one or more portions of a data ingestion component of the security platform 120. In some implementations, the ingestion metrics 211 can indicate a quantity, type, source, or received frequency of security data received at the security platform 120. In some implementations, the ingestion metrics 211 can indicate that a portion of the security data has been deleted before it was ingested to the security platform 120. In some implementations, the ingestion metrics 211 can indicate that a portion of the security data that was ingested at the security platform appears to be fabricated. In some implementations, deletion or fabrication of security data can be used by entities, such as unauthorized users or third parties, to hide intentional misuse of the security platform 120. In some implementations, the ingestion metrics 211 can indicate the status of software or hardware components of the security platform 120. For example, and in some implementations, a failure of a hardware component may cause the quantity of security data that is received at the ingestion component of the security platform 120 to change significantly. Thus, if the quantity of security data ingested at the security platform 120 changes rapidly (e.g., “spikes”), it may be an indication of a software or hardware failure of the security platform 120, or a computing environment managed by the security platform 120. In some implementations, the ingestion metrics 211 can be affected by one or more changes to configuration settings for how the ingestion component receives security data from a client organization and processes the security data for the security platform 120. In some implementations, the ingestion metrics 211 can be used to determine whether changes have been made to the ingestion component of the security platform 120. In some implementations, the ingestion metrics 211 can be associated with a portion of change metadata 231 of configuration data, described below. For example, the change metadata 231 can indicate one or more changes to the parsing component that resulted in a change in the ingestion metrics 211.

Parsing metrics 212 can indicate a performance of one or more portions of a parsing component of the security platform 120. For example, parsing metrics 212 may indicate a quantity of ingested data that has been parsed over a particular duration. In another example, the parsing metrics 212 may indicate a number of data items that are classified as a certain data type, such as a number of log files in security data that are classified as printer log files. In another example, the parsing metrics 212 may indicate a distribution of fields into which a data item is parsed, such as a system identifier field, a user identifier field, a timestamp field, an error field, etc. For instance, the parsing metrics 212 may indicate that 10% of a log file was parsed into the system identifier field, 5% of the log file was parsed into the user identifier field, 5% of the log file was parsed into the timestamp field, 50% of the log file was parsed into the error field, and the remaining contents of the log file were discarded. In some implementations, the parsing metrics 212 can be affected by one or more changes to configuration settings for how the parsing component extracts information from security data into predefined data fields and processes the security data for the security platform 120. In some implementations, the parsing metrics 212 can be used to determine whether changes have been made to the parsing component of the security platform 120. In some implementations, the parsing metrics 212 can be associated with a portion of change metadata 231 of configuration data, described below. For example, the change metadata 231 can indicate one or more changes to the parsing component that resulted in a change in the parsing metrics 212.

Alert generation metrics 213 can indicate a performance of one or more portions of an alert generation component of the security platform 120. The alert generation metrics 213 can include one or more of a number of alerts generated from specific security data (e.g., parsed data received from the parsing component, ingested data received from the ingestion component, or raw security data received from the organization), types of alerts generated from the specific security data, a frequency of alerts generated from the specific security data (e.g., over a certain duration), or the like. In some implementations, the alert generation metrics 213 can be affected by one or more changes to configuration settings for how the alert generation component generates alerts based on security data received at the security platform 120. In some implementations, the alert generation metrics 213 can be used to determine whether changes have been made to the alert generation component of the security platform 120. For example, changes in the alert generation metrics 213 can be the result of changes to security rules that generate the alerts, the creation or deletion of various security rules, or the like. For instance, a change in the alert generation metrics 213 may indicate, in part, that a security rule has been created or altered in a way to subvert the purpose of the security platform 120, or otherwise exploit a weakness of the security platform 120. In some implementations, the alert generation metrics 213 can be associated with a portion of change metadata 231 of configuration data, described below. For example, the change metadata 231 can indicate one or more changes to the parsing component that resulted in a change in the alert generation metrics 213.

User access metrics 214 can indicate a performance of one or more portions of a user access component of the security platform 120. The user access metrics 214 can include one or more of numerical representations of user interactions with the security platform 120, such as a quantity of user requests, a quantity of changes to configuration settings of the security platform, or the like. In some implementations, the user access metrics 214 is associated with a portion of change metadata 231 of configuration data 230, described below. The user access metadata can can include user search queries, files accessed by the user, or changes made by the user to the configuration settings of the security platform, other user interactions with the security platform 120, timestamps associated with the user interactions, or the like. That is, the user access metadata can indicate what the user did, (e.g., the changes made to the configuration settings of the security platform), and not just that the user did something (e.g., the numeric user access metric increasing each time the user request to access the configuration settings, or each time the user makes a change to the configuration settings). In another example, a user may use one or more tools of the security platform 120 to perform an unauthorized surveillance of another user of the organization. The user access metadata associated with the user access metrics 214 could include the actions taken by the user at the security platform 120, including how configuration settings may have been altered to perform the unauthorized surveillance. In some implementations, the user access metrics 214 can be used to determine whether changes have been made to the user access component of the security platform 120.

Security data 220 can include data received from one or more client organizations that use the security platform. In some implementations, the security data 220 is data that pertains to, or is received from a particular client organization, such as client organization 102 of FIG. 1. Security data 220 can include telemetry data such as log files produced by operating systems, middleware, and/or applications that reflect actions which occurred at specific moments in time on a computing resource, or the like, as described above. In some implementations, and as described herein, the model can be trained on historical security data during a period of time that has been labeled as normal operation for the security platform. During inference, current security data is provided as input to the trained AI model. The trained AI model can determine, using the current configuration settings data and the current security data, one or more outputs 202.

Configuration data 230 can include or represent aggregated numerical or textual representations of configuration settings for the security platform 120, as described above. In some implementations, portions of the configuration data 230 that correspond to other inputs 201 can be used as inputs 201. For example, if particular ingestion metrics 211 are used as inputs 201, the portion of the configuration data related to the particular ingestion metrics 211 can be used as an input 201. The configuration data 230 can include changes metadata 231.

Changes metadata 231 can include information, such as a changelog, associated with changes in various metrics of the performance metrics 210, such as the ingestion metrics 211, the parsing metrics 212, the alert generation metrics 213, or the user access metrics 214. In some implementations, the changes metadata 231 pertains to a particular duration. In some implementations, the changes metadata 231 is generated for specified changes to the configuration settings. For example, changes metadata 231 may be generated if a high-priority configuration setting is changed, while changes metadata 231 may not be generated is a low-priority configuration setting is changed. In some implementations, the changes metadata 231 is generated if a particular performance metric exceeds an acceptable operating threshold condition.

In some implementations, the changes metadata 231 can include information specifying the type of changes, previous version(s) of the configuration data 230, a time the changes occurred, an entity that performed the changes, or the like. In some implementations, the changes metadata 231 can indicate one or more changes that were made to the configuration data 230 in connection with the ingestion metrics 211, the parsing metrics 212, the alert generation metrics 213, or the user access metrics 214 to misconfigure the security platform 120, whether accidentally or intentionally. In some implementations, the changes metadata 231 can indicate whether the changes were made in response to other changes in the system, either manually or automatically. For example, if the value of a particular setting of configuration data 230 is changed, it may trigger the value of other settings of the configuration data 230 to also change. Thus, the changes metadata 231 can include information that describes the initial change to the configuration settings, as well as subsequent changes to the configuration settings that occurred as a result of the initial change.

Baseline data 240 can include one or more performance metrics that have been identified by the security platform 120 as normal operations of the security platform 120. In some implementations, the baseline data 240 are predefined, such as by an organization, users of the organization, or the security platform 120. In some implementations, the baseline data 240 are determined by an AI model, such as the diagnostic model 160. In some implementations, the AI model can be a supervised AI model that is trained on input data that is labeled or associated with a predefined performance baseline for the security platform 120. Historical performance metrics, historical security data, and/or historical configuration data can be provided as input to the trained supervised AI model to determine baseline data 240 for the security platform 120. In some implementations, the AI model can be an unsupervised AI model that is trained on historical performance data, historical security data, and/or historical configuration data to identify one or more patterns from the input data. In such implementations, the baseline data 240 is not necessarily a separate dataset as shown, but is represented or “learned” by the unsupervised AI model. When current performance data, security data, and/or configuration data is provided to the unsupervised AI model, the unsupervised AI model can determine to what level the current input data matches the “expected” baseline data 240 that has been trained into the unsupervised AI model.

The performance data 261 can represent a current overall performance of the security platform 120, as described above. In some implementations, the performance data 261 can include raw numerical values that indicate a functionality of the security platform. In some implementations, the performance data 261 can represent one or more values that are internal to the diagnostic model 160. The diagnostic model 160 can be trained to determine deviations in current operations of the security platform from a predefined baseline (e.g., baseline data 240). That is the model can be trained to generate a deviation score 262 as an output 202 from inputs 201 including the performance metrics 210 and the security data 220.

The deviation score 262 can represent a difference between the current performance data, such as performance data 261, and a predefined baseline, such as baseline data 240. In some implementations, the deviation score 262 is generated as the output from the trained AI model to indicate the extent of deviation from the predefined baseline of the security platform (e.g., based on baseline data 240, or a learned or trained baseline in the AI model). In some implementations, the deviation score 262 includes a deviation value that corresponds to each performance metric 210 (e.g., ingestion metrics 211, parsing metrics 212, alert generation metrics 213, user access metrics 214). In some implementations, the AI model can be trained to generate a single deviation score 262 that is based on the multiple inputs 201, including the various metrics of the performance metrics 210. In some implementations, the deviation score 262 can be used during inference to determine whether to perform one or more of the remediation steps 263. For example, and in some implementations, after the security platform 120 receives the deviation score 262 as an output from the trained AI model, the security platform can compare the deviation score 262 to a security threat criterion. The security threat criterion can represent a maximum value of the deviation score 262 that, if exceeded, causes the security platform 120 to perform one or more remediation steps 263 to reduce the value of the deviation score 262. For example, if the performance data 261 indicates that a rate of data ingestion is significantly different from a rate of data parsing, and the difference in those two rates is greater than a predefined difference (e.g., a baseline difference), then the deviation score 262 can satisfy the security threat criterion. That is, the deviation score 262 can be greater than the maximum value of the deviation score 262 for the predefined baseline performance of the security platform 120.

Remediation steps 263 can include one or more methods, processes, or operations to reduce the deviation score 262, such as the examples of remediation steps 263 described above with reference to FIG. 1. In some implementations, the remediation steps 263 can include one or more methods, processes, or operations to return the security platform to a predefined performance baseline (e.g., baseline data 240). In some implementations, the security platform 120 can implement one or more of the remediation steps 263 obtained from the trained AI model. In some embodiments, the security platform 120 can use the outputs of the trained AI model, such as diagnostic model 160, to determine one or more remediation steps 263. In some implementations, the security platform 120 can cause one or more of the remediation steps 263 to be presented in a GUI associated with the security platform 120.

FIG. 3 illustrates a flow diagram of an example of a method 300 for training an AI model, according to some aspects of the disclosure. The method is performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In other implementations, one or more operations of method 300 can be performed by training set generator 250 as described with respect to FIG. 2. It can be noted that components described with respect FIGS. 1-2 can be used to illustrate aspects of FIG. 3. In some implementations, the operations (e.g., operations 301-308) can be the same, different, fewer, or greater. For example, in some implementations one or more training inputs can be generated or one or more target outputs can be generated, and the one or more training inputs and one or more training outputs can be used as input-output pairs (for input) to train the AI model, such as the diagnostic model 160 of FIG. 1.

Method 300 generates a training dataset for an AI model. In some implementations, at operation 301, processing logic implementing the method 300 initializes the training set “T” to an empty set (e.g., “{}”).

At operation 302, the processing logic generates a training input including configuration setting data for the security platform.

At operation 303, the processing logic generates a training input including security data obtained by the security platform.

At operation 304, the processing logic generates one or more target outputs for the training inputs. In some implementations, a target output includes one or more security metrics that represent the current operations of the security platform. In some implementations, a target output includes one or more deviation scores based on the security metrics for the current operations of the security platform. In some implementations, a deviation score may be determined for each metric. In alternative implementations, a combined deviation score is determined for the current operations of the security platform as a whole. In some implementations, a target output includes one or more remediation steps. The one or more remediation steps can be performed at the security platform to reduce the deviation score. In some implementations, the one or more remediation steps can cause the security platform to return to normal operations.

At operation 305, the processing logic optionally generates mapping data that is indicative of an input/output mapping. The input/output mapping (or mapping data) may refer to the training input (e.g., one or more of the training inputs described herein), the set of target outputs for the training input (e.g., one or more of the target outputs described herein), and an association between the training input(s) and the target output(s).

At operation 306, the processing logic adds the mapping data generated at operation 305 to training set T.

At operation 307, the processing logic branches based on whether training set T is sufficient for training the AI model, such as the diagnostic model 160 of FIG. 1. If so, execution proceeds to operation 308, otherwise, execution continues back at operation 302. It should be noted that in some implementations, the sufficiency of training set T may be determined based simply on the number of input/output mappings in the training set, while in some other implementations, the sufficiency of training set T may be determined based on one or more other criteria (e.g., a measure of diversity of the training examples, accuracy satisfying a threshold, etc.) in addition to, or instead of, the number of input/output mappings.

At operation 308, the processing logic provides training set T to train the AI model (e.g., diagnostic model 160). In one implementation, training set T is provided to a training engine 141 of server machine 140 to perform the training as described with reference to FIG. 1. In the case of a neural network, for example, input values of a given input/output mapping (e.g., numerical values associated with inputs 201) are input to the neural network, and output values (e.g., numerical values associated with outputs 202) of the input/output mapping are stored in the output nodes of the neural network. The connection weights in the neural network are then adjusted in accordance with a learning algorithm (e.g., back propagation, etc.), and the procedure is repeated for the other input/output mappings in training set T. After operation 308, the AI model (e.g., diagnostic model 160) can be trained using training engine 141 of server machine 140. The trained AI model (e.g., diagnostic model 160) can be implemented the diagnostic module 151 of the security platform 120 as described with reference to FIG. 1.

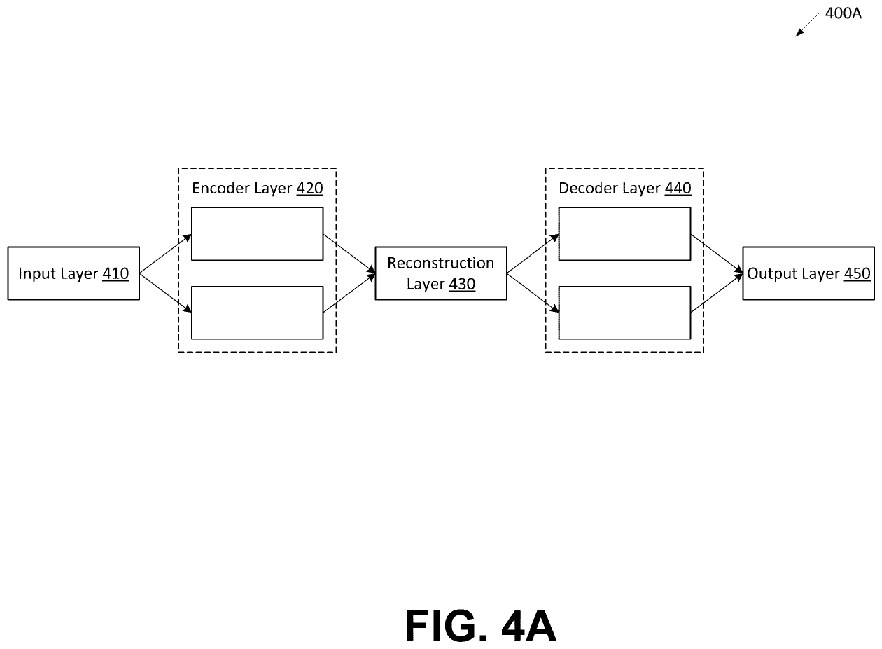

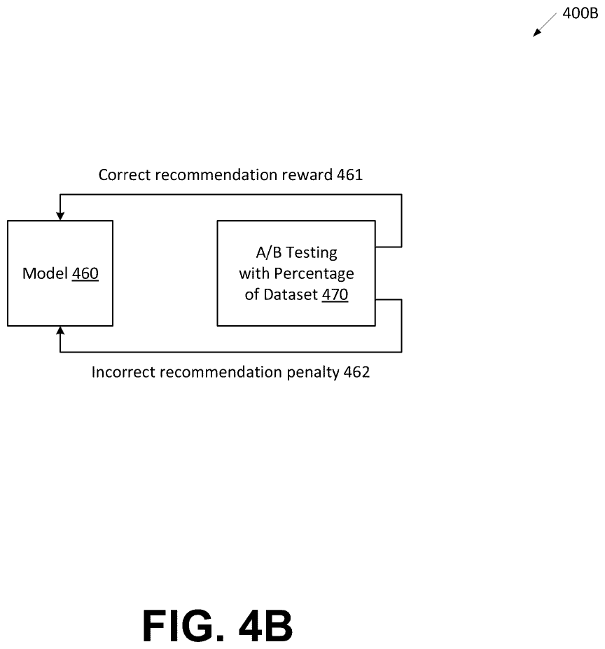

FIG. 4A illustrates an example of a convolutional neural network (CNN) 400A to train an AI model to determine a deviation of operations of a security platform from a predefined baseline, according to aspects of the disclosure. The CNN 400A includes an input layer 410, a first hidden layer (e.g., an encoder layer 420), a reconstruction layer 430, a second hidden layer (e.g., decoder layer 440), and an output layer 450.

At the input layer 410, raw data is provided to the CNN 400A as an input. In some implementations, the raw data can be configuration setting data, such as configuration settings data, security data, or the like, such as is described regarding inputs 201 of FIG. 2. In some implementations, the input layer 410 can perform one or more preprocessing operations on the raw data to facilitate the use of the raw data by the CNN 400A. For example, and in some implementations, the input layer 410 can normalize the raw data a specific data type, data size, or the like based on the processing requirements of the CNN 400A.

At the encoder layer 420, or the first hidden layer, a convolutional operation can be performed on the data received from the input layer 410. A convolutional operation can extract one or more features from the data received from the input layer 410. In some implementations, a matrix (also referred to as a kernel) slides over the data received from the input layer 410. The kernel may perform element-wise multiplication at each position of the data and sum the results of the element-wise multiplication to identify one or more features in the data received from the input layer 410.

At the reconstruction layer 430, the CNN 400A can attempt to reconstruct the raw input data received at the input layer 410, using the convoluted output from the encoder layer 420. In some implementations, multiple outputs from the encoder layer 420 are combined into a single dataset. The combination of the multiple outputs from the encoder layer 420 may be performed using, for example, layer pooling, down-sampling, dimensional reduction, translation invariance, or the like.

At the decoder layer 440, or second hidden layer, a deconvolution operation can be performed on the data received from the reconstruction layer 430. In some implementations, the deconvolution operation can up-sample the data received from the reconstruction layer 430 to increase the spatial resolution of the data. A learned kernel (from training the CNN 400A) can slide over the reconstructed data received from the reconstruction layer 430. The learned kernel may perform element-wise multiplication at each position to spread out the reconstructed data to fill the up-sampled spatial resolution. In some implementations, the decoder layer 440 can reconstruct one or more data structural patterns of the original raw data provided to the input layer 410.

During the training of the CNN 400A, encoder weights of the encoder layer and decoder weights of the decoder layer can be adjusted. The encoder weights affect how the encoder kernel processes the input data from the input layer 410, and the decoder weights affect how the decoder kernel processes the reconstructed data from the reconstruction layer 430. In some implementations, the encoder weights and/or the decoder weights can be related to one or more extracted, or identified performance metrics of the security platform. For example, the encoder weights and decoder weights can correspond to determining how different aspects of the operations of the security platform contribute to a normal operation of the security platform.

At the output layer 450, the decoded data received from the decoder layer 440 can be post-processed. In some implementations, the output can be processed by one or more of a normalizing function, a probabilistic function, or the like. For example, a Softmax function can convert the raw output scores in decoded data into probabilities that sum to 1. In another example, a sigmoid activation function can combine the raw output scores into a single output value between 0 and 1, indicating a probability that the input data corresponds to the trained class. In another example, a linear regression function can produce a real-world value based on the input data.

FIG. 4B illustrates an example deployment strategy 400B for the CNN 400A for determining a deviation of operations of a security platform from a predefined baseline, according to aspects of the disclosure. The deployment strategy 400B includes the model 460 and a deployment operation 470 which performs A/B testing with a percentage of a dataset.

During the deployment operation 470, outputs from the model 460 are evaluated. When the model 460 makes a correct recommendation, the model 460 is given a reward 461. When the model 460 makes an incorrect recommendation, the model 460 is given a penalty 462. In some implementations, the deployment operation 470 is automated. That is, the output from the model 460 can be automatically evaluated for whether the recommendation is correct or not, and given a reward 461 or a penalty 462, respectively. In some implementations, a portion of the deployment operation 470 may be manually performed by a user.

In some implementations, receiving the reward 461 for a particular output can cause the model 460 to adjust one or more hidden weights (e.g., an encoder weight of the encoder layer 420 or a decoder weight of the decoder layer 440 in the CNN 400A of FIG. 4A). Similarly, in some implementations, receiving the penalty 462 for a particular output can cause the model 460 to adjust one or more hidden weights of the CNN 400A of FIG. 4A.

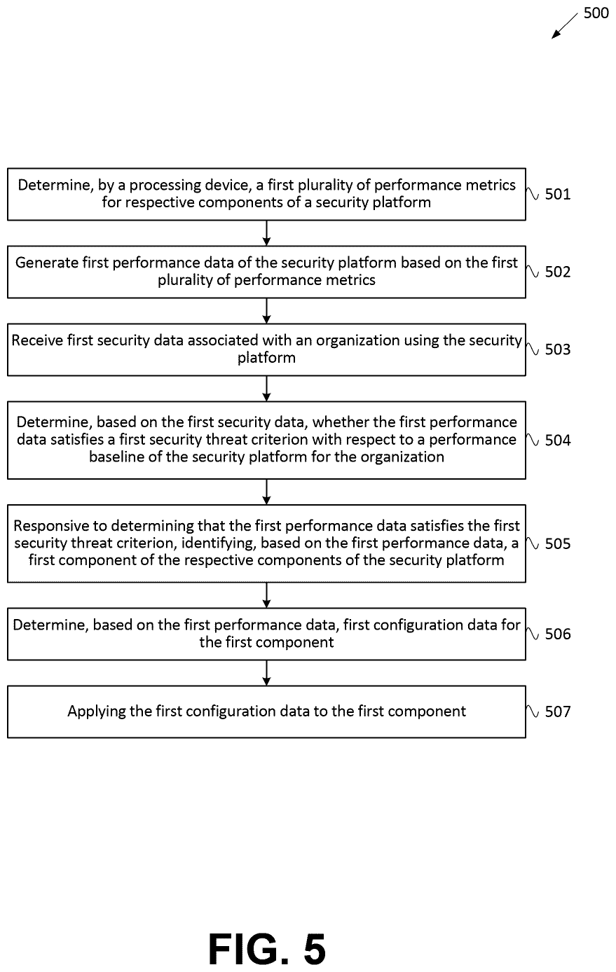

FIG. 5 is a flow diagram of an example method 500 for diagnostic and remediation processes for a security platform, according to some aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 501, the processing logic performing the method 500 determines a first plurality of performance metrics for respective components of a security platform. These performance metrics can be any of the performance metrics which are described above, such as those described with reference to FIG. 2.

At operation 502, the processing logic generates first performance data of the security platform based on the first plurality of performance metrics. As described above, the performance data can reflect an overall performance of the security platform, based on various collected performance metrics.

At operation 503, the processing logic receives first security data associated with an organization using the security platform. In some implementations, the first security data includes fabricated security data, such as fabricated log data. The fabricated log data can be an indication that a misconfiguration of the security platform (or other potential security threat) was performed intentionally, as opposed to accidentally.

At operation 504, the processing logic determines, based on the first security data, whether the first performance data satisfies a first security threat criterion with respect to a first performance baseline of the security platform for the organization. In some implementations, the specified entity is an organization that uses the security platform, such as client organization 102 of FIG. 1. In some implementations, the processing logic can determine a severity associated with the first security data that satisfies the first security threat criterion.

In some implementations, the first performance baseline is determined by a trained artificial intelligence (AI) model that is trained to identify one or more performance metrics of the security platform. The processing logic can provide the first security data and configuration data of the security platform, such as performance metrics 210 of FIG. 2, as input to the trained AI model. The processing logic can receive an output from the trained AI model. The output can indicate performance data based on the first security data and the configuration data. In some implementations, the first security data and the configuration data are each labeled as performance baseline data. In some implementations, the first security data and the configuration data correspond to a shared historical duration.

In some implementations, to determine whether the first performance data satisfies the first security threat criterion with respect to the first baseline associated with the specified entity, the processing logic can provide the first security data and the first plurality of performance metrics as input to a trained AI model. The trained AI model can be configured to determine current performance data as an output from the given inputs, and identify a deviation of current performance data from historical performance data. In some implementations, the processing logic can further provide configuration data of the security platform as input to the trained AI model. In some implementations, the first security data and the configuration data correspond to a shared period of time.

At operation 505, responsive to determining that the first performance data satisfies the first security threat criterion, the processing logic identifies based on the first performance data, a first component of the respective components of the security platform. In some implementations, components of the security platform can include, for example, one or more of a data ingestion component, a data parser component, a alert generation component, a user access component, or a configuration data component (e.g., for adjusting configuration settings of the security platform, as described herein).

At operation 506, the processing logic determines, based on the first performance data, first configuration data for the first component.

At operation 507, the processing logic applies the first configuration data to the first component of the security platform. In some implementations, the first configuration data is applied to the first component as a part of a remedial operation. In some implementations, the first configuration data is identified based on a severity of a potential security threat.

In some implementations, after the first configuration data is applied to the first component, the processing logic can receive, by the security platform, second security data. The processing logic can determine whether the first performance data satisfies the first security threat criterion based on the second security data. Responsive to determining the first performance data does not satisfy the first security threat criterion, the processing logic generates an indication that the performing of the remedial action was successful. The processing logic can cause the first indication to be visually rendered in a graphical user interface (GUI). In some implementations, responsive to determining the second security data does not satisfy the first security threat criterion, the processing logic can generate a second indication that performing the remedial action was unsuccessful and cause the second indication to be visually rendered via the GUI.

In some implementations, after the first configuration data is applied to the first component, the processing logic can determine a second plurality of performance metrics. The processing logic can generate second performance data based a second plurality of performance metrics. The processing logic can determine whether the second performance data satisfies the first security threat criterion based on the first security data.

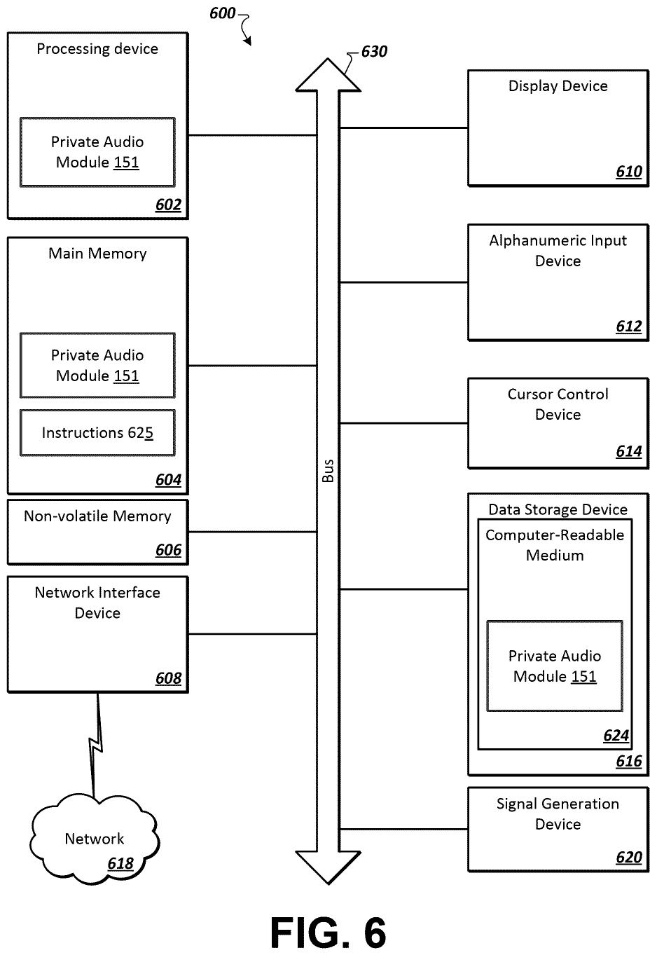

FIG. 6 is a block diagram illustrating an example of a computer system 600, according to aspects of the disclosure. The computer system 600 can correspond to security platform 120 and/or client devices 102A-102N, described in FIG. 1. Computer system 600 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 600 includes a processing device 602 (e.g., a processor), a main memory 604 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 606 (e.g., flash memory, static random access memory (SRAM), etc.), and a data storage device 616, which communicate with each other via a bus 630. In some implementations, the main memory 604 can be a non-transitory computer readable storage medium.

Processing device 602 represents one or more general-purpose processing devices such as a microprocessor, central processing unit, or the like. More specifically, processing device 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 can also be one or more special-purpose processing devices such as an application specific integrated circuit (ASIC), a field programmable gate array (FPGA), a digital signal processor (DSP), network processor, or the like. The processing device 602 is configured to execute network interface device 608 (e.g., for synchronizing data between platforms) for performing the operations discussed herein. The processing device 602 can be configured to execute instructions 625 stored in main memory 604. Non-volatile memory 606 can store the instructions 625 when they are not being executed, and can store additional system data that can be accessed by processing device 602.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker).

The data storage device 616 can include a computer-readable storage medium 624 (e.g., a non-transitory machine-readable storage medium) on which is stored one or more sets of instructions 625 (e.g., for generating variations of a translated audio portion) embodying any one or more of the methodologies or functions described herein. The instructions can also reside, completely or at least partially, within the main memory 604 and/or within the one or more processing devices (e.g., the processing device 602) during execution thereof by the computer system 600, the main memory 604 and the processing device 602 also constituting machine-readable storage media. The instructions can further be transmitted or received over a network 620 via the network interface device 608. In some implementations, one or more processing devices can be operatively coupled to the main memory 604 to perform various operations.

While the computer-readable storage medium 624 (non-transitory computer-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one implementation,” “an implementation,” or “an implementation,” means that a specific feature, structure, or characteristic described in connection with the implementation and/or implementation is included in at least one implementation and/or implementation. Thus, the appearances of the phrase “in one implementation,” or “in an implementation,” in various places throughout this specification can, but are not necessarily, referring to the same implementation, depending on the circumstances. Furthermore, the specific features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. Such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
determining, by a processing device, a first plurality of performance metrics for respective components of a security platform;
generating first performance data of the security platform based on the first plurality of performance metrics;
receiving first security data associated with an organization using the security platform;
determining, based on the first security data, whether the first performance data satisfies a first security threat criterion with respect to a performance baseline of the security platform for the organization;
responsive to determining that the first performance data satisfies the first security threat criterion, identifying, based on the first performance data, a first component of the respective components of the security platform;
determining, based on the first performance data, first configuration data for the first component; and
applying the first configuration data to the first component.

2. The method of claim 1, further comprising:
determining a second plurality of performance metrics for the respective components of the security platform;
generating second performance data of the security platform based on the second plurality of performance metrics;
determining, based on the first security data, whether the second performance data satisfies the first security threat criterion;
responsive to determining that the second performance data does not satisfy the first security threat criterion, generating a first indication that applying the first configuration data to the first component was successful; and
causing the first indication to be visually rendered via a graphical user interface (GUI).

3. The method of claim 1, further comprising:
determining a second plurality of performance metrics for the respective components of the security platform;
generating second performance data of the security platform based on the second plurality of performance metrics;
receiving second security data from the organization using the security platform;
determining, based on the second security data, whether the second performance data satisfies the first security threat criterion;
responsive to determining that the second performance data satisfies the first security threat criterion, generating a first indication that applying the first configuration data to the first component was unsuccessful; and
causing the first indication to be visually rendered via a graphical user interface (GUI).

4. The method of claim 1, wherein the first security data comprises fabricated log data.

5. The method of claim 1, wherein generating the first performance data based on the first plurality of performance metrics comprises:
providing the first plurality of performance metrics as a first input to an artificial intelligence (AI) model trained to generate performance data for the security platform;
providing the first security data as a second input to the AI model; and
receiving a first output from the AI model, wherein the first output comprises the first performance data.

6. The method of claim 5, the method further comprising:
providing configuration data for the security platform as a third input to the AI model; and
receiving a second output from the AI model, wherein the second output comprises the first configuration data for the first component.

7. The method of claim 1, wherein the respective components of the security platform include at least one of a data ingestion component, a data parsing component, an alert generation component, or a user access component.

8. The method of claim 1, wherein the performance baseline of the security platform for the organization is determined using an artificial intelligence (AI) model trained to generate performance data based on one or more patterns in a plurality of performance metrics, the method further comprising:
providing a plurality of historical performance metrics as a first input to the AI model;
providing historical security data as a second input to the AI model; and
receiving an output from the AI model, wherein the output comprises the performance baseline of the security platform for the organization.

9. A system comprising:
a memory; and
one or more processing devices communicatively coupled to the memory to perform operations comprising:
determining, by a processing device, a first plurality of performance metrics for respective components of a security platform;
generating first performance data of the security platform based on the first plurality of performance metrics;
receiving first security data associated with an organization using the security platform;
determining, based on the first security data, whether the first performance data satisfies a first security threat criterion with respect to a performance baseline of the security platform for the organization;
responsive to determining that the first performance data satisfies the first security threat criterion, identifying, based on the first performance data, a first component of the respective components of the security platform;
determining, based on the first performance data, first configuration data for the first component; and
applying the first configuration data to the first component.

10. The system of claim 9, the operations further comprising:
determining a second plurality of performance metrics for the respective components of the security platform;
generating second performance data of the security platform based on the second plurality of performance metrics;
determining, based on the first security data, whether the second performance data satisfies the first security threat criterion;
responsive to determining that the second performance data does not satisfy the first security threat criterion, generating a first indication that applying the first configuration data to the first component was successful; and
causing the first indication to be visually rendered via a graphical user interface (GUI).

11. The system of claim 9, the operations further comprising:
determining a second plurality of performance metrics for the respective components of the security platform;
generating second performance data of the security platform based on the second plurality of performance metrics;
receiving second security data from the organization using the security platform;
determining, based on the second security data, whether the second performance data satisfies the first security threat criterion;
responsive to determining that the second performance data satisfies the first security threat criterion, generating a first indication that applying the first configuration data to the first component was unsuccessful; and
causing the first indication to be visually rendered via a graphical user interface (GUI).

12. The system of claim 9, wherein the first security data comprises fabricated log data.

13. The system of claim 9, wherein generating the first performance data based on the first plurality of performance metrics comprises:
providing the first plurality of performance metrics as a first input to an artificial intelligence (AI) model trained to generate performance data for the security platform;
providing the first security data as a second input to the AI model; and
receiving a first output from the AI model, wherein the first output comprises the first performance data.

14. The system of claim 13, the operations further comprising:
providing configuration data for the security platform as a third input to the AI model;
and receiving a second output from the AI model, wherein the second output comprises the first configuration data for the first component.

15. The system of claim 9, wherein the respective components of the security platform include at least one of a data ingestion component, a data parsing component, an alert generation component, or a user access component.

16. The system of claim 9, wherein the performance baseline of the security platform for the organization is determined using an artificial intelligence (AI) model trained to generate performance data based on one or more patterns in a plurality of performance metrics, the operations further comprising:
providing a plurality of historical performance metrics as a first input to the AI model;
providing historical security data as a second input to the AI model; and
receiving an output from the AI model, wherein the output comprises the performance baseline of the security platform for the organization.

17. A method comprising:
generating a first training input of a training dataset, the first training input comprising a plurality of performance metrics for respective components of a security platform;
generating a second training input of the training dataset, the second training input comprising first security data received from an organization at the security platform, wherein the plurality of performance metrics and the first security data correspond to a shared period of time;
generating a first training output corresponding to the first training input and the second training input, wherein the first training output identifies a deviation of current performance data for the security platform from a performance baseline for the security platform; and
utilizing the training dataset to train an AI model on (i) a set of training inputs comprising the first training input and the second training input, and (ii) a set of training outputs comprising the first training output.

18. The method of claim 17, wherein the first security data comprises fabricated log data.

19. The method of claim 17, further comprising:
generating a third training input comprising historical configuration data for the security platform, wherein the set of training inputs comprises the third training input; and
generating a second training output comprising first configuration data for a first component of a plurality of components of the security platform, wherein the set of training outputs comprises the second training output.

20. The method of claim 19, wherein the plurality of components comprise at least one of a data ingestion component, a data parsing component, an alert generation component, or a user access component.
